(19) United States
(12) Patent Application Publication
(10) Pub. No.: US 2005/0159216 A1
(43) Pub. Date: Jul. 21, 2005

(54) Simulation game system and method thereof integrating geographical information

(76) Inventors: Chaucer Chiu, Taipei (TW); Clark Yu, Shanhai City (CN)

Correspondence Address: RABIN & CHAMPAGNE, P.C.;Suite 500, 1101 14 Street, N.W., Washington, DC, 20005, US

(21) Appl. No.: 10/759,264

(22) Filed: Jan. 20, 2004

(51) Int. Cl. A63F 13/00

(52) U.S. Cl. 463/31

(57) ABSTRACT

A simulation game system and a Geographical Information System (GIS) are associated to provide realistic game backgrounds in real-time. The game background generating process includes performing overlay computing on vector layer data, grid layer data and background objects to create more realistic game backgrounds. Geographical information provided by the Geographical Information System assist the player in deciding the adequate game strategies to be adopted.

### BACKGROUND OF THE INVENTION

1. Field of Invention

The present invention relates to a simulation game system and method, and more particularly to simulation game system and method that associate with a Geographical Information System (GIS) to create game backgrounds in real-time and provide geographical information.

2. Related Art

Simulation games are currently very popular and attract many players in their virtual game world.

A very important aspect of simulation games is the creation of the game background. The creation of a game background usually necessitates the consideration of several aspects:
(1) The game background has to be realistic to attract the player over a long interval of time, so that she/he feels completely immerged in the simulated world of the game.
(2) The game background has to be switched smoothly. Because the course of a game usually requires a great amount of different backgrounds, the way of creating and displaying the background dynamically constitutes an essential factor to the continuity of the game.

Current techniques generally call for the assembly of graphics to form the game backgrounds. In other words, available graphics are differently associated to form different backgrounds of the game. Though this technique is easily and widely implemented, it requires the storage of a great amount of graphic data and is not suitable for the background level of detail. Other disadvantages of the technique of the prior art include non-realism of the background adjustment and slow and resource-consuming generation of the game background.

On the other hand, another important aspect of a simulation game is the interaction between game and player. Generally, successful simulation games are those that can achieve highly interactive events and can continuously attract and interest the player in the course of the game without being bored. Unfortunately, present simulation games have limited abilities to exhibit interactive events.

Therefore, there is a need for a new simulation game design that can improve the quality of the game and the interactivity with the player, so that the simulation game is more attractive.

### SUMMARY OF THE INVENTION

It is therefore an objective of the invention to provide a simulation game system and method that can overcome the disadvantages of the prior art by integrating a Geographical Information System therein.

According to an aspect of the invention, vector layer data and grid layer data provided by the Geographical Information System are combined with the background objects and overlay computing will be carried out, so as to create more realistic and precise game backgrounds.

According to another aspect of the invention, game events are combined with geographical information provided by the Geographical Information System, so that the player can obtain actual and adequate information to adopt appropriate strategies or to make right decisions.

To accomplish the above and other objectives, a simulation game system of the invention comprises a manipulation-displaying module, a logic computing module, a Geographical Information System, a game database, and a background generator module.

According to other aspects of the invention, a simulation game method is provided. The simulation game method comprises:
(1) The background generating process, including the following steps. First of all, a move signal is detected when a game character move, the game character's coordinate data will be computed and created based on the detected result. Secondly, a display area corresponding to the game character coordinate data is delivered and map layer data are accessed. Thirdly, according to coordinates of the display area and vector layer data, a first map overlay computing is performed. After this, according to the coordinates of the display area and grid layer data, a second map overlay computing is performed. Then, background object data are read in the display area and a game background is created. Finally, the game background is displayed in real-time.
(2) The interacting process in a game, including the following steps. A trigger signal first is detected and corresponding event coordinate data are generated. Event coordinate data corresponding to the trigger signal then are outputted. If the event coordinate data correspond to a geographical information event, geographical information corresponding to the event coordinate data is retuned via the Geographical Information System. Lastly, the display is updated.

Because the invention does not use the assembly of graphics, prior problems such as graphics storage and resource consuming can be prevented, while the functionality of free levels of details can be provided in the simulation game. By combining geographical information and game events, the invention further can improve the game interactivity and realism.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and is thus not limitative of the present invention, wherein:

FIG. 1 is a block diagram of a simulation game system integrating geographical information according to an embodiment of the invention;

FIG. 2 is a flowchart of a background generating process implemented in a simulation game system and method according to an embodiment of the invention;

FIG. 3 is a flowchart of a geographical information accessing process implemented in a simulation game system method according to an embodiment of the invention;

FIG. 4 is a schematic view illustrating a game background creation in a simulation game system and method integrating geographical information according to an embodiment of the invention; and

FIG. 5 through FIG. 7 are schematic views of a geographical information analysis and display implemented in a simulation game system and method according to an embodiment of the invention.

### DETAILED DESCRIPTION OF THE INVENTION

The invention describes a simulation game system and method that incorporates geographical data. A geographical information database 125 of a geographical information system 120 provides geographical information. Geographical information differs from usual data provided by a conventional management information system, and includes spatial data with specific attributes as well as topological relations. Map layer data can be thereby displayed and geographical information can be subjected to inquiry and analysis. Geographical Information System is generally known in the field of computer science, and per se do not constitute the subject of the invention.

The success of simulation games generally resides in aspects such as realism, continuity, and interactivity. However, current techniques generally do not allow obtaining satisfactory results of these basic requirements. A major aspect of the invention is therefore to associate a Geographical Information System 120 with a simulation game system, so that while the game is being played, the Geographical Information System 120 can provide map layer data to build a more realistic game background. Events occurring in the course of the game may be further associated with geographical information so as to improve the game interactivity, and thereby overcome some of the prior problems of simulation games.

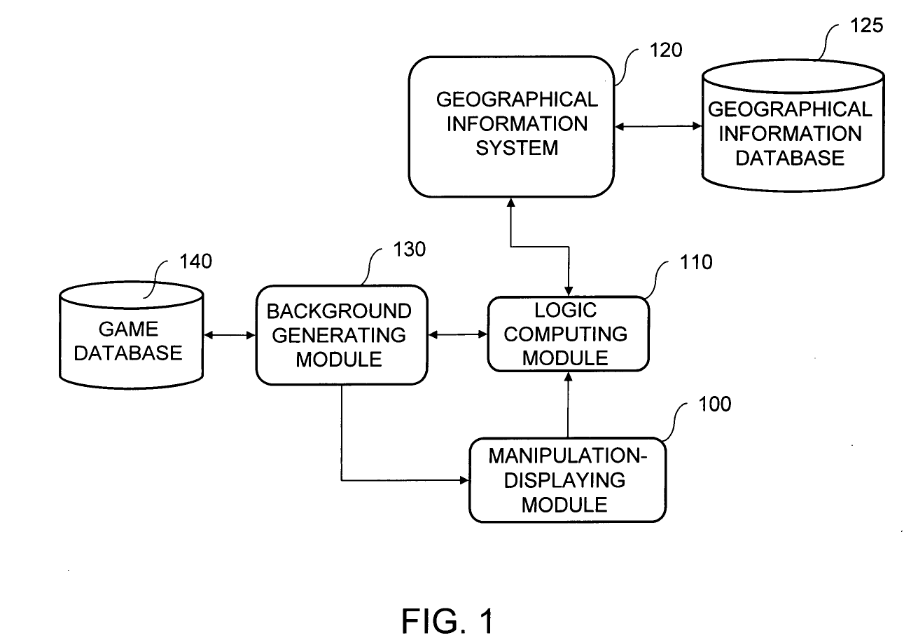

FIG. 1 is a block diagram of a simulation game system according to an embodiment of the invention. The system includes a manipulation-displaying module 100, a logic computing module 110, a geographical information system 120, a background generating module 130, and a game database 140.

The manipulation-displaying module 100 receives a manipulating action from the player. Manipulating actions generally can be divided into game characters moves and game triggering events, which respectively produce move signals and trigger signals.

Move signals mean that a game character(s) is moving and, therefore, the environmental background surrounding the moving character(s) has to be updated and redisplayed. On the other hand, trigger signals mean that a game character(s) enters a predetermined game event, including a game course event or a geographical information event. Therefore, the game course has to be executed.

The logic-computing module 110 performs fast logic computing and signal category evaluation. When a move signal is received, the logic-computing module 110 computes the coordinate data of the current game character in movement and determines a corresponding display area. The display area usually corresponds to a maximal visible area from the current position coordinates of the game character.

When a trigger signal is received, the logic-computing module 110 performs logic computing of corresponding event coordinate data, as well as signal evaluation. According to the location of the event coordinate data: if it is determined that the trigger signal relates to a game course event, the event coordinate data are transferred via the background generating module 130 to the game database 140 so as to read and execute a predetermined game course sequence. In contrast, if it is determined that the trigger signal corresponds to a geographical information event, the event coordinate data are transferred via the geographical information system 120 to the geographical information database 125 so as to access corresponding geographical information.

The Geographical Information System 120 provides map layer information such as vector layer data, grid layer data, etc., corresponding to the display area outputted from the logic-computing module 110. Furthermore, the Geographical Information System 120 provides a geographical information analysis corresponding to event coordinate data outputted from the logic-computing module 110.

All map layer data and geographical information are stored in the geographical information database 125, being connected to the Geographical Information System 120. In addition, the map layer data and geographical information respectively correspond to preset event coordinate data.

The background generator module 130 receives map layer data from the Geographical Information System 120 to perform overlay computing and form a game background.

Overlay computing means that the vector layer data and the grid layer data of the map layer data are overlaid according to coordinate data, a 3-dimentions game background will be created based on the layer contents. Furthermore, the game background may include background objects data preset in the display areas.

The background generator module 130 additionally executes a game course sequence corresponding to event coordinate data transmitted from the logic-computing module 110.

The game database 140 stores game course sequences corresponding to event coordinate data and background object data corresponding to display areas.

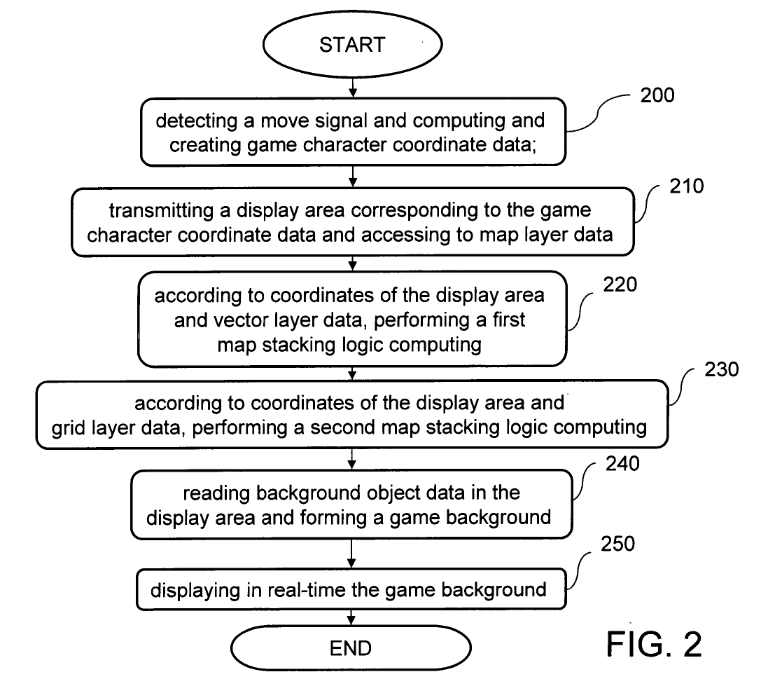

FIG. 2 is a flowchart of a game background generating method according to an embodiment of the invention. At the start and in the course of the game, character(s) may continuously move and therefore require the generation of game backgrounds. Therefore, move signals from the player's manipulation are continuously detected, and character coordinate data of the current character's position are calculated in real-time (step 200). A display area corresponding to the character coordinate data is transmitted to access to map layer data (step 210). During step 210, the maximal visible area around the game character is determined and used as principal reference for accessing to corresponding map layer data during the background creation. According to the display area data and the vector layer data, the first map overlay computing is performed (step 220). At step 220, vector layer data according to their coordinates are displayed on the display area. According to the display area coordinates and the grid layer data, the second map overlay computing then is performed (step 230). At step 230, grid layer data according to their coordinates are displayed on the display area. Background objects data of the display area then are read, and a game background is created (240). At step 240, background objects data preset as being positioned in the display area are actually placed in the display area, and a 3-dimensions game background, incorporating vector layer data, grid layer data, and background object data is formed. Lastly, the game background is displayed on the current display area of the game character (step 250).

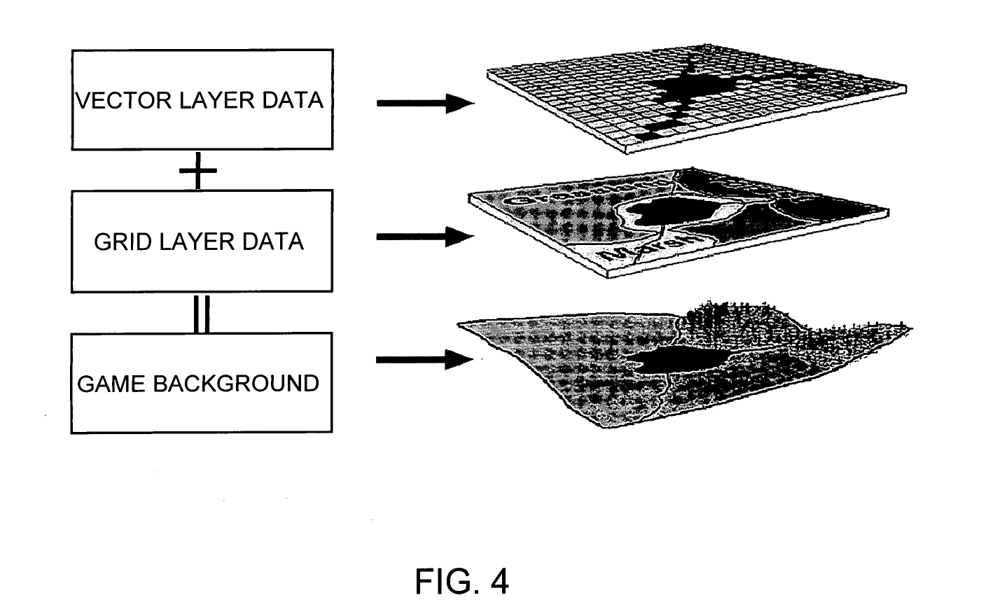

FIG. 4 is a flowchart of a overlay computing method implemented in an embodiment of the invention. Via this method, the created game background is more realistic, and the background generating can be more efficient.

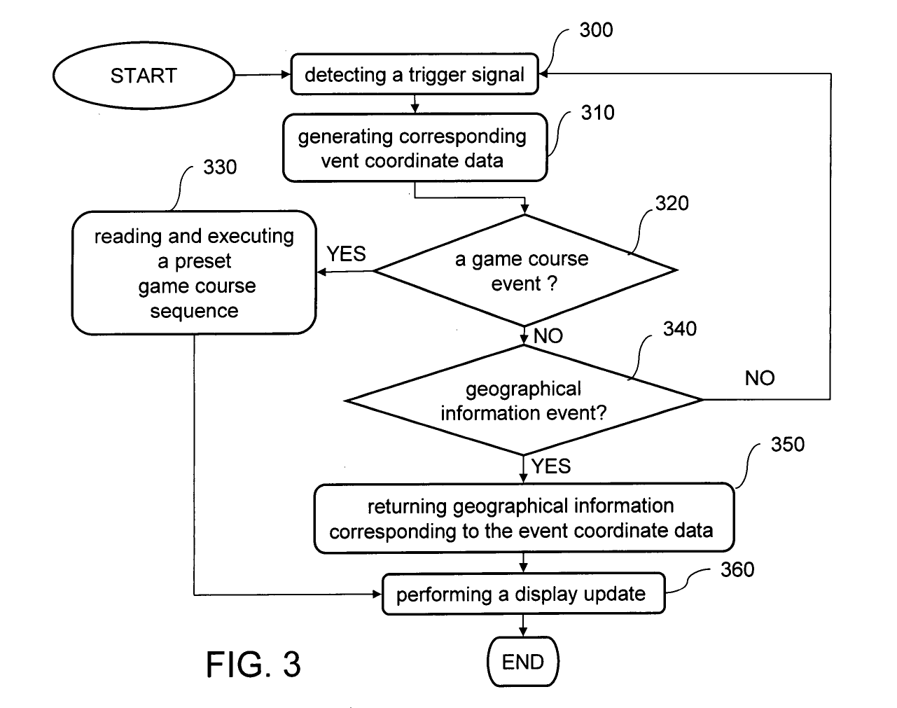

Now reference is made to FIG. 3 that describes a flowchart of a geographical information accessing method according to an embodiment of the invention. The invention integrates the Geographical Information System 120 in the game course so that the player can access in real-time to geographical information used for game strategy reference, which thereby can improve interaction with the player.

A game usually includes preset events that can be triggered by the player during the game process. Therefore trigger signals are continuously detected in the game (step 300). The generation of trigger signals can come from automatic comparing detections of character coordinate data or player manipulation actions. After the trigger action is determined, event coordinate data corresponding to the trigger signal are delivered (step 310). Events can be classified into game course events and geographical information events. Accordingly, it is determined whether the position of the event coordinate data corresponds to a game course event (step 320). If so, the background generator module 130 reads and executes game course sequence(s) stored in the game database (step 330). After the game course sequence has been executed, the display is updated (step 360). If the position of the event coordinate data otherwise corresponds to a geographical information event, the logic computing module 110 transfers the event coordinate data to the Geographical Information System 120, to access corresponding geographical information which then are fed back to the game (step 340). The display accordingly is updated (step 360). If event coordinate data of a trigger signal do not correspond to either a game course event or a geographical information event, it means that the trigger signal is invalid. At this time, the flow returns to step 300 to continue detecting trigger signals.

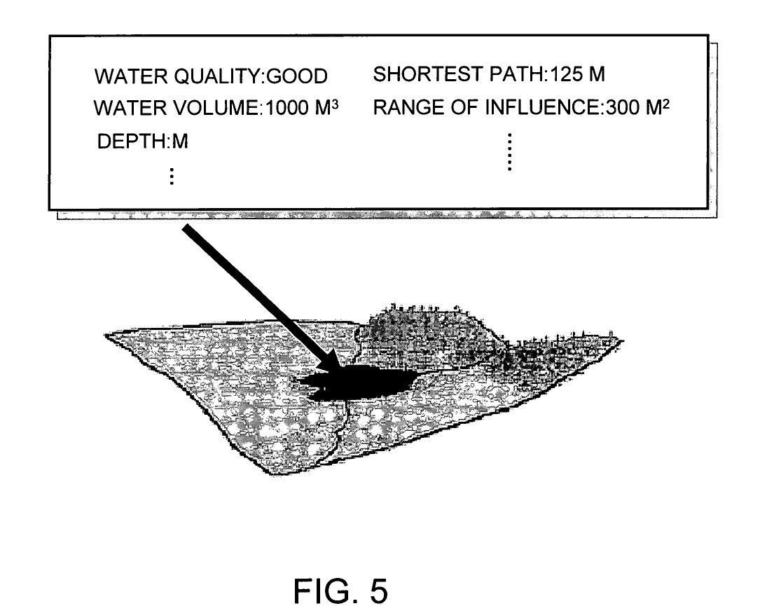

FIG. 5 through FIG. 7 are schematic views illustrating a geographical information analysis and display according to an embodiment of the invention. In the example of FIG. 5, if the player triggers a “lake” geographical information event in the game background, the game displays geographical information relating to the triggered “lake” including general information (such as the water quality, the water volume, depth, etc.), analysis information (such as the shortest path or range of influence). The player thereby can choose proper strategy or make correct decision, this extremely enhances the game's sense of reality.

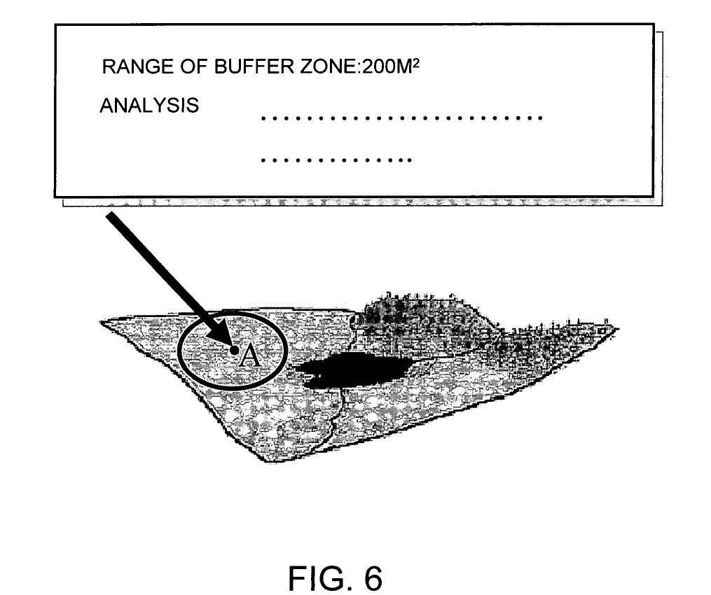

In the example of FIG. 6, if the player triggers a preset location A in the game background and desires to establish a factory at this location, geographical information relating to a buffer zone is analyzed with respect to the location A. An optimal buffer zone then is suggested to the player for building the desired factory (as shown by the encircled zone in the figure). In addition, further detailed information can be provided to the player about possible environmental factors and events that may occur after the factory has been completed, so that the player can decide whether the factory ultimately should be set up in the buffer zone.

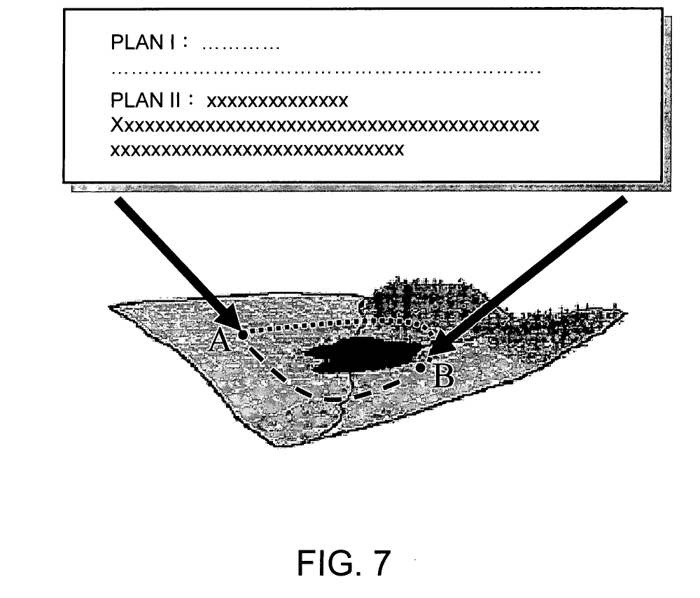

In the example of FIG. 7, if the player triggers preset locations A, B in the game background and desires to create a road between A and B, a route analysis is performed about geographical information relating to the construction of a road between A and B. Different routes then may be proposed to the player for the road (as shown by dotted lines in the figure). The player further may be informed of advantages and disadvantages corresponding to each situation. According to the current environmental configuration and available resource in the game process, the player thereby can be guided to choose the road to be created. As a result, geographical information therefore can be advantageously associated into the simulation game.

As described above, in addition to basic geographical information display, the geographical analysis can include aspects such as analyses of buffer zones or pathways, but may include other aspects such as analyses of the space topology, slope inclination, 3D views, tendency forecast, etc. All these and other aspects can be integrated in a simulation game according to the invention so as to improve the game interactivity and realism.

It will be apparent to the person skilled in the art that the invention as described above may be varied in many ways, and notwithstanding remaining within the spirit and scope of the invention as defined in the following claims.

1. A simulation game system, integrating geographical information provided by a geographical information system for forming a game background and creating game course interaction, the system comprising:
a manipulation displaying module, displaying a game background according to a move signal generated by a manipulating action, and operating a game course according to a trigger signal generated by another manipulating action;
a logic computing module, receiving a move signal and performing logic computing of character coordinate data and a corresponding display area respectively, and further receiving a trigger signal and performing logic computing of corresponding event coordinate data;
a geographical information system, providing map layer data according to the display area and performing geographical information analysis corresponding to the event coordinate data, wherein the geographical information system further comprises:
a geographical information database, storing the map layer data corresponding to the display area and the geographical information corresponding to the event coordinate data;
a game database, storing a plurality of game course sequences corresponding to the event coordinate data, and a plurality of background object data corresponding to the display area; and
a background generator module, receiving the map layer data to perform stacking logic computing and generate the game background, and further executing a game course sequence according event coordinate data.

2. The simulation game system of claim 1, wherein the map layer data comprises at least vector layer data and grid layer data.

3. The simulation game system of claim 1, wherein the geographical information analysis comprises at least a buffer zone analysis, a route analysis, a space topology analysis, a slope inclination analysis, a 3-dimensions view analysis, or a tendency forecast analysis.

4. The simulation game system of claim 1, wherein the display area is a maximal visible area from the character coordinate data.

5. A simulation game method, integrating geographical information provided by a Geographical Information System for forming a game background and creating game course interaction, the method comprising:
detecting a move signal and computing and creating game character coordinate data;
transmitting a display area corresponding to the game character coordinate data and accessing to map layer data;
according to coordinates of the display area and vector layer data, performing a first map overlay computing;
according to coordinates of the display area and grid layer data, performing a second map overlay computing;
reading background objects data in the display area and forming a game background; and displaying in real-time the game background.

6. The simulation game method of claim 5, wherein the map layer data comprises at least vector layer data and grid layer data.

7. The simulation game method of claim 5, wherein the display area is a maximal visible area from the character coordinate data.

8. A simulation game method, integrating geographical information provided by a Geographical Information System for forming a game background and creating game course interaction, the method comprising:
detecting a trigger signal and generating corresponding event coordinate data;
transmitting the event coordinate data corresponding to the trigger signal;
if the event coordinate data correspond to a geographical information event, returning geographical information corresponding to the event coordinate data via the geographical information system; and performing a display update.

9. The simulation game method of claim 8, further comprising reading and executing a preset game course sequence corresponding to the event coordinate data when the event coordinate data correspond to a game course event.

10. The simulation game method of claim 8, returning geographical information corresponding to the event coordinate data via the geographical information system further comprises performing a geographical information analysis, wherein the geographical information analysis includes at least a buffer zone analysis, a route analysis, a space topology analysis, a slope inclination analysis, a 3-dimensions view analysis, or a tendency forecast analysis.
